(19) United States
(12) Patent Application Publication
(10) Pub. No.: US 2005/0185053 A1
(43) Pub. Date: Aug. 25, 2005

(54) Motion targeting system and method

(76) Inventors: Thomas F. Berkey, Tavernier, FL (US); Steven W. Schieltz, Boca Raton, FL (US); Lawrence R. Mills, Coral Springs, FL (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 10/784,449

(22) Filed: Feb. 23, 2004

(51) Int. Cl. H04N 7/18

(52) U.S. Cl. 348/155; 348/143

(57) ABSTRACT

A system and method for monitoring moving objects in a video system. The system includes at least one video camera; and at least one motion detector. The motion detector may include a lens having a field of view fixedly directed to an area of interest, and an imager for receiving an image through the lens and converting the image to video data. The motion detector may be configured to monitor the video data for movement of an object in the field of view and provide a detector output in response to the movement of the object. The detector output may be configured to cause adjustment of at least one operating characteristic of the video camera to target the camera on the object. A motion detector and methods of monitoring a multiplicity of moving objects are also provided.

### TECHNICAL FIELD

The present invention relates to a motion targeting system and method, and, in particular, to motion targeting of moving objects in a video system.

### BACKGROUND

Systems for detecting and tracking moving objects through use of a video camera are known. Generally, such systems include algorithms for identifying and/or tracking motion in a video output of a camera or group of cameras. Tracking of the image may be achieved by controlling the pan-tilt-zoom (PTZ) of the camera. As used herein, PTZ refers to any imaging device associated with a camera, such as conventional video cameras, video surveillance domes, etc.

Several difficulties are associated with conventional motion detection and tracking systems. For example, tracking an object using a moving camera requires more powerful processors performing more extensive calculations. Also, when a camera is tracking an object, other objects can move into areas outside the current field of view without detection. The more zoomed in the camera is, the less surrounding area is covered and the easier it is to miss detecting significant events outside of the field of view or to loose track of an object because it slipped out of the field of view.

Fixed mount wide-angle cameras can track multiple objects simultaneously over large areas, but conventionally could not digitally zoom in on an object with enough resolution to facilitate positive identification. Wide-angle cameras with a high pixel resolution imager have been developed to provide improved digital zoom capability, but the digitally zoomed resolution of known wide-angle cameras remains much lower than current technology optical zoom cameras. Cameras with high pixel density imagers are also cost prohibitive compared to optical zoom cameras, and have slow frame rates because of the magnitude of pixels that must be processed during each frame.

A system approach using a stationary wide-angle video camera to track objects and command another camera is expensive. Very low cost wide-angle motion detectors, e.g. PIR sensors, etc., generally do not have sufficient resolution or intelligence to accurately control an associated camera. Covering a wide area with multiple, discrete, low cost motion detectors configured to target a camera requires a large number of sensors to obtain sufficient resolution.

In view of difficulties such as these, many currently installed systems do not include motion detection capability. Instead, a camera is operated in an automatic scanning mode with an output recorded on a time lapse or multiplexed recording device. These systems can cover a wide area with acceptable recording media requirements, but miss a significant amount of activity because they scan a wide space, with a single, relatively narrow field of view. A camera with a wider field of view can provide more continuous coverage, but requires a higher resolution, non-standard camera and expansive memory to provide sufficient resolution.

Accordingly, there is a need for a system and method for detecting and/or tracking moving objects in a video system in a cost efficient and reliable manner.

### BRIEF DESCRIPTION OF THE DRAWINGS

For a better understanding of the present invention, together with other objects, features and advantages, reference should be made to the following detailed description which should be read in conjunction with the following figures wherein like numerals represent like parts:

FIG. 1 is a block diagram of an exemplary embodiment of a motion tracking system consistent with the present invention;

FIG. 2 is a schematic illustration of an exemplary motion tracking system consistent with the present invention;

FIG. 3 is a block diagram of an exemplary motion detector consistent with the present invention;

FIG. 4 is a block flow diagram of an exemplary method of targeting or tracking a moving object consistent with the present invention; and

FIG. 5 is schematic illustration of a system configuration consistent with the invention including multiple detectors.

### DETAILED DESCRIPTION

For simplicity and ease of explanation, the present invention will be described herein in connection with various exemplary embodiments thereof. Those skilled in the art will recognize, however, that the features and advantages of the present invention may be implemented in a variety of configurations. It is to be understood, therefore, that the embodiments described herein are presented by way of illustration, not of limitation.

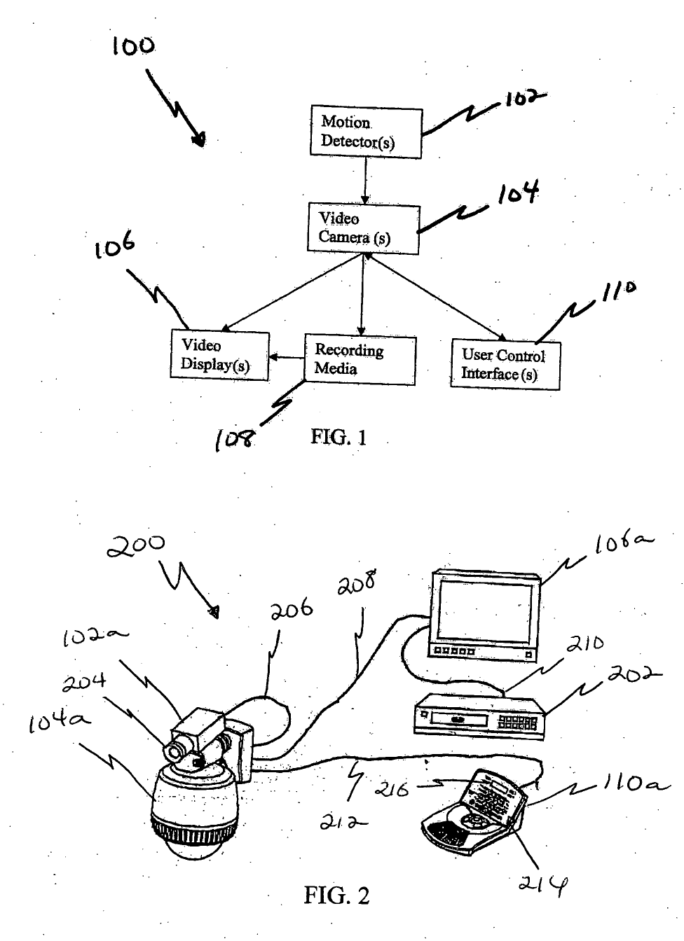

Turning now to FIG. 1, there is illustrated, in simplified block diagram form, an exemplary motion tracking system consistent with the invention. The system 100 includes: an image sensor based motion detector 102 for controlling the PTZ of at least one video camera 104. The video camera 104 may be coupled to a video display device 106 for displaying a video output of the camera 104 and recording media 108 for storing the video output.

The video camera(s) 104 may be any of a variety of cameras known in the art having analog or digital video output. Where multiple cameras 104 are coupled to the motion detector 102, mixtures of camera types and configurations may be provided. The camera(s) may have one or more camera operating characteristics including PTZ condition, focus, etc., that may be controlled by a user control interface 110 coupled thereto. The control interface 110 may provide user initiated control signals to the camera(s). In response to the control signals received at the camera, motors may be operated to change one or more of the camera's 104 operating characteristics.

Those skilled in the art will recognize a variety of configurations for the recording media 108 and video display 106. For example, the display 106 may be directly coupled to the camera, or may be coupled thereto through other devices, such as video matrix switches, video multiplexers, etc (not shown). The recording media 108 may be any fixed or removable machine-readable media configured for storing representations of the camera video output, and may be provided as a component of a video recorder, such as digital or analog tape recorders, write-once or re-writable video disk recorders, and/or DVD recorders. The recording media 108 may be coupled to the video display 106 for selective display of recorded or buffered video data.

Although the illustrated components are shown as separate components in the illustrated exemplary embodiment, those skilled in the art will recognize that one or more of the components may be combined into a single component. For example, the user control interface 110 may be presented as a graphical user interface on the video display 106. Also, in embodiments including multiple cameras 104, each camera may be associated with one or more motion detectors 102, video displays 106, recording media 108, and user interfaces 110, or the cameras may be configured to share one or more of these devices.

The devices 102, 104, 106, 108, 110 may be communicatively coupled by transmission media in a variety well known configurations. The transmission media may be any medium capable of transmitting signals between the particular devices, such as a coaxial cable, twisted pair wire, fiber optic cable, air, etc. Protocols for facilitating such communicative coupling are well known, and need not be further described herein.

FIG. 2 illustrates one exemplary embodiment 200 of a system consistent with the invention. In the illustrated embodiment, only one video camera 104a, motion detector 102a, display 106a, recording device 202 and control interface 110a is shown for simplicity and ease of explanation. Again, it is to be understood that various combinations of one or more of these components may be provided in a system consistent with the invention.

In the illustrated exemplary embodiment, the video camera 104a is configured as a dome-type camera. Dome-type cameras are well known to those skilled in the art, and are often used in surveillance applications. A motion detector 102a consistent with the invention is fixedly mounted to the camera 104a. The motion detector 102a may include a lens 204, e.g. a wide-angle lens, and an associated imager and video processing logic. When changes associated with a moving object are detected, the detector 102a may provide an output via cable 206 to control the PTZ of the camera 104a to pan, tilt or zoom to capture the moving object with an optimum or desired resolution.

The video output of the camera 104a may be coupled via cable 208 to the display device 106a, e.g. a video monitor, for displaying the output. The recording device 202, e.g. a digital video recorder, may be coupled for receiving and recording the video output on a recording media via cable 210, e.g. in response to the detector output. The user control interface 110a may be coupled to the camera via cable 212 and may include a console including user input keys 214 and a display 216. A variety of user control interfaces are known. The user control interface may be configured for providing user-initiated control commands to the camera and/or the motion detector via cables 212 and 206. For example, a user may initiate control functions from the interface to manually control the PTZ of the camera, the on/off state of the camera 104a and/or motion detector 102a, and/or to download software updates to the camera and/or motion detector.

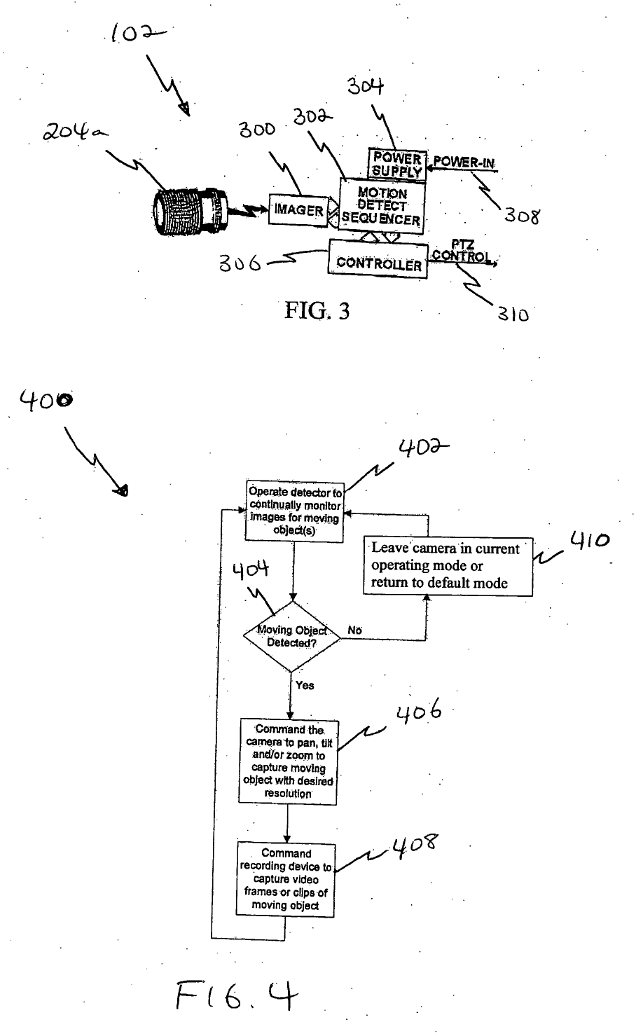

Turning now to FIG. 3, there is provided a block diagram of an exemplary motion detector 102 consistent with the invention. As shown, the detector 102 includes a lens 204a that directs an image onto an imager 300, a motion detect sequencer 302, a power supply 304, and a controller 306. The power supply 304 may be any of a variety of conventional power supplies, and may be configured for receiving and converting power input, e.g. on line 308, to regulated DC supply voltages for supplying the imager 300, motion detect sequencer 302, and controller 306.

The lens 204a may be any of a variety of known lenses for directing an optical image onto the imager 300. In one embodiment, the lens 204a may be a conventional wide-angle lens to provide wide-angle viewing and detection of objects within a wide-angle field of view. As used herein, “wide-angle” when used in reference to a lens or detector shall refer to a lens or detector having a field of view greater than 50 degrees. This would include fisheye lenses that have a 180 degree field of view or greater.

In a manner well-known to those skilled in the art, the imager 300 converts the optical image from the lens 204a to an electrical representation of the image. The imager 300 may be any of a variety of imagers known in the art. However, since the resolution required for the imager to achieve acceptable motion detection is much less than the resolution required for object recognition, the imager 300 may be a low resolution, standard density, low-cost imager including, for example, a complimentary metal oxide semiconductor (CMOS) imager or a charge coupled device (CCD) imager. As used herein, “low resolution” when used in reference to an imager shall refer to an imager having a resolution of less than 380 vertical lines and “high resolution” when used in reference to an imager shall refer to an imager having a resolution of 480 vertical lines or greater.

The output of the imager 300 may be provided to the motion detect sequencer 302, which may include video processing logic for applying any of a number of well-known algorithms to continually monitor the video images for moving objects. Generally, the motion detect sequencer 302 buffers and monitors video frames for changes between successive frames. When, for example, the background is a fixed/motionless background, any changes from one video frame to the next represents a moving object.

From the location of the object within a video frame, the rate of change of the object in the frame, assumptions concerning object size, etc., the sequencer 300 may provide an output to the controller 306 representative of the location, speed and distance of the object relative to the detector 102. The controller may be configured or programmed for providing a PTZ control output on line 310 for controlling the PTZ of at least one associated camera in response to the output from the sequencer 302. For example, the controller may be configured to provide an output to the camera to cause the camera to pan, tilt, and/or zoom to capture the object with an optimum or desired resolution.

The controller 306 may be any type of electronic circuit capable of providing the speed and functionality required by the embodiments of the invention. For example, the controller may be configured as a microprocessor, field programmable gate array (FPGA), complex programmable logic device (CPLD), application specific integrated circuit (ASIC), or other similar device. In an embodiment where the controller is configured as a microprocessor, the processor could be a processor from the Pentium® family of processors made by Intel Corporation, or the family of processors made by Motorola. Software instructions for causing the controller/processor to provide an appropriate output may be stored on any machine-readable media capable of storing instructions adapted to be executed by the processor/controller. As used herein, the phrase “adapted to be executed by a processor” is meant to encompass instructions stored in a compressed and/or encrypted format, as well as instructions that have to be compiled or installed by an installer before being executed by the processor.

Although a variety of imagers 300 may be used in a detector consistent with the invention, use of a low resolution imager reduces image-related buffer memory sizes associated with the sequencer as well as processing speed required for image processing. These reductions in size and speed result in lower system cost. Lower cost lenses may also be used since some minor distortion does not significantly effect detection of most objects.

Also, the images processed by the detector 102 may not require viewing, e.g. on a video display. As such, motion detection in a system consistent with the invention may be performed on raw image data without the extensive processing required for human viewing. For example, a detector consistent with the invention may perform motion detection on the raw data without application of well-known visual perception algorithms conventionally applied to facilitate human visual perception on a display. As used herein “visual perception algorithms” shall refer to known algorithms for color space correction (Bayer to RGB to YUV, etc.), color purity correction, pixel to pixel sensitivity (gain and offset compensation), stuck pixel compensation, gamma correction and encoding to a standard such as CCIR-656, NTSC or PAL, etc. Omitting such algorithms allows for relatively simple detector electronics and lower system cost compared to the use of a common video camera with built-in motion detection or other known detector configurations. Although these advantages are most significantly achieved by omitting all of these algorithms, a system consistent with the invention may omit any one or more of these algorithms. Also, these advantages may also be achieved by applying such algorithms to only some limited portion of the raw image data.

Those skilled in the art will recognize that noise filtering algorithms, may still be required to prevent false motion detection in a system consistent with the invention, depending on system requirements and the lens and imager quality. Monitoring color space information from a color sensor may also be implemented in a detector consistent with the invention. However, a black and white imager may be used to achieve reasonable motion detection at very low cost.

Moreover, use of a detector and camera consistent with the invention provides significant advantages over use of high resolution imagers with built-in motion detection. The independent detector allows for un-interrupted motion detection coverage of an area of interest. The detector output can cause the camera to aim and zoom in on moving objects, while also commanding a recording device to capture segments of the camera video output, e.g. through a serial communication port or alarm inputs to the recording device. The detector may be configured to be compatible with most known PTZ cameras and recording devices, allowing system customization for diverse requirements of resolution, cost, zoom capabilities, etc. A system consistent with the invention also, for example, achieves better low light capability, better automatic gain control, full 30 frames per second (or more) update rate, and allows use of mature image enhancement algorithms for the video output. Moreover, in a system incorporating a camera with optical zoom, loss of resolution associated with digital zoom may be avoided.

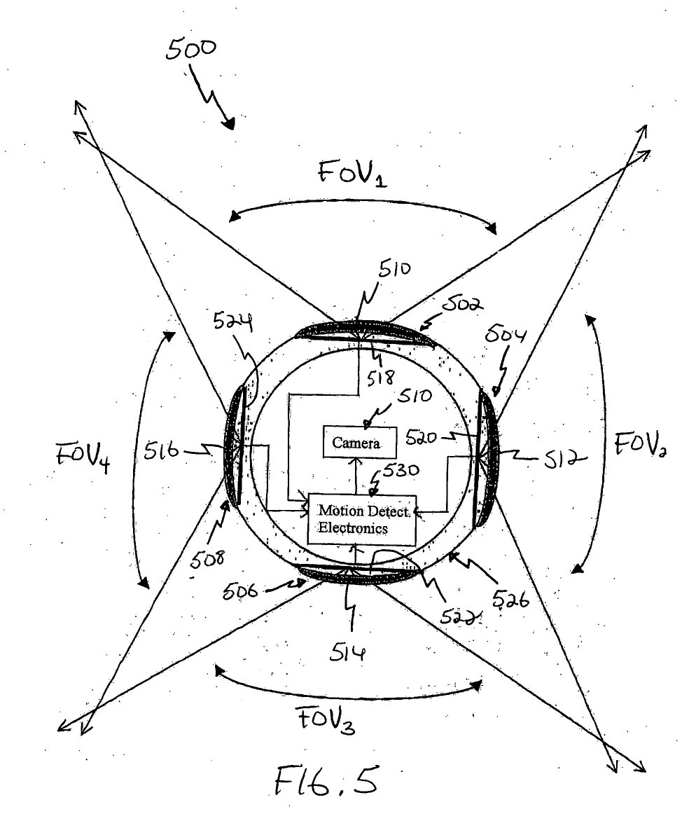

FIG. 4 is a block flow diagram of a method 400 consistent with one exemplary embodiment of the invention. The block flow diagram of FIG. 4 includes a particular sequence of steps. It can be appreciated, however, that the sequence of steps merely provides an example of how the general functionality described herein can be implemented. Further, each sequence of steps does not have to be executed in the order presented unless otherwise indicated.

As shown, the detector continually monitors 402 received images for changes indicative of a moving object. During this time the camera may be allowed to operate independently according to a default pattern or user-initiated scanning pattern, e.g. in a wide-angle scanning pattern. In a configuration where the detector is secured to a fixed location, the background of the detector's field of view may always be stationary. Running default patterns or jumping between any wide-angle or zoomed views with the video camera will not effect motion detection since the camera and detector operate independently.

When changes associated with a moving object are detected 404, the detector may provide an output to command 406 the camera to pan, tilt and/or zoom to capture moving object with an optimum or desired resolution. The detector output may also command 408 a recording device to capture frames or video clips of the moving object. In one embodiment, after targeting the object or area of activity for a predetermined amount of time, the detector may command the camera to move to another area of activity to capture another moving object. The detector may thus be configured to command the camera to independently track multiple moving objects by cycling between views of the targets, e.g. with optimized resolution, while simultaneously commanding a recording device to capture frames or video clips of each moving object. When no moving objects are detected 404, the camera may be left in its current operating mode or returned to a default mode 410, e.g., a wide-angle scanning pattern, to maximize value of the video content for live viewing or recording.

In one embodiment, the detector may be configured to command the recording device to record a varying number of images per second based on the nature of the video activity in terms of amount, frequency or other parametric measure. This may provide improved use of limited recording media for storage of the most desirable video for security or other applications. This spatial compression also allows the recording media to be optimized for use over a longer period of time, and can greatly increase the probability of recording the most important video content. In addition to a motion targeting application, a system consistent with the invention may be used for automatic tracking wherein the detector may lock on to a moving object and record the object as it moves around without regard to spatial compression.

Again, a system consistent with the invention may include a variety of detector and camera configurations. For example, a single detector may be used to target multiple cameras. In such an embodiment, different cameras may be commanded to track different moving objects and/or multiple moving objects while one or more recording devices are commanded to record video associated with the objects. Also, multiple detectors may be configured to coordinate with each other to control multiple cameras and to control the selection of video streams to recorders from the cameras and/or fixed cameras not controlled by the detector.

FIG. 5 is a schematic representation of a system configuration 500 consistent with the invention including multiple detectors 502, 504, 506, 508 arranged in a ring around a camera 510 controlled by the detectors. In the illustrated exemplary embodiment 500, each of four detectors 502, 504, 506, 508 is represented by an associated lens 510, 512, 514, 516 and an associated imager 518, 520, 522, 524. The detectors are equally spaced along around an exterior surface of an annular ring 526. The annular ring 526 may be positioned above or below the camera 510, or the camera may be disposed completely or partially in the interior of the ring. Providing the annular ring 526 around the camera in such a manner may simplify calibration of the spatial coordinates between the detectors 502, 504, 506, 508 and the camera 510. The fixed arrangement allows calibration at the factory, thus eliminating a time consuming setup during installation.

The field of view for each lens 510, 512, 514, 516 is identified by the angles FOV₁, FOV₂, FOV₃ and FOV₄, respectively As shown, the fields of view for the lenses may overlap, thus providing a continuous 360 degree view around the camera 510. Motion detection electronics 530, e.g. including a sequencer and controller as described above, may receive and time multiplex the respective outputs of the imagers 518, 520, 522, 524 and mask off overlapping fields of view areas. Dewarping compensation may be performed for each command to the camera 510, as opposed to on a real-time pixel-by-pixel basis, if desired to minimize cost by simplifying the electronics. Any of a variety of known dewarping algorithms may be used.

There is thus provided a system and method for monitoring moving objects in a video system. According to one aspect of the invention, the system includes at least one video camera, and at least one motion detector. The motion detector may include a lens having a field of view fixedly directed to an area of interest, and an imager for receiving an image through the lens and converting the image to video data. The motion detector may be configured to monitor the video data for movement of an object in the field of view and to provide a detector output in response to the movement of the object. The detector output may be configured to cause adjustment of at least one operating characteristic of the video camera to target the camera on the object. According to one embodiment, the lens may be a wide-angle lens and the detector output may control the pan, tilt and zoom of the camera to target the camera on the object.

According to another aspect of the invention there is provided a method of monitoring a moving object in a video system. The method includes providing at least one motion detector consistent with the invention, operating the motion detector to continually monitor video data to detect movement of the moving object; and providing an output from the motion detector in response to the movement to cause adjustment of at least one operating characteristic of a video camera to target the camera on the moving object.

According to yet another aspect of the invention there is provided a method of monitoring multiple moving objects in a video system. The method includes providing at least one motion detector consistent with the invention, operating the motion detector to continually monitor the video data to detect movement of the moving objects; providing a first output from the motion detector in response to the movement of a first one of the objects to cause adjustment of at least one operating characteristic of a video camera to target the camera on the first one of the moving objects; and providing a second output from the motion detector in response to the movement of a second one of the objects to cause adjustment of at least one operating characteristic of the video camera to target the camera on the second one of the moving objects. The detector may provide record commands to cause a recording media to record at least a portion of the video camera output while the camera is targeted on the first and second objects.

The embodiments that have been described herein, however, are but some of the several which utilize this invention and are set forth here by way of illustration but not of limitation. Many other embodiments, which will be readily apparent to those skilled in the art, may be made without departing materially from the spirit and scope of the invention.

1. A system comprising:
at least one video camera; and
at least one motion detector comprising a lens having a field of view fixedly directed to an area of interest, and an imager for receiving an image through said lens and converting said image to video data,
said motion detector being configured to monitor said video data for movement of an object in said field of view without application of at least one visual perception algorithm to said video data, and to provide a detector output in response to said movement of said object, said detector output being configured to cause adjustment of at least one operating characteristic of said video camera to target said camera on said object.

2. A system according to claim 1, wherein said video camera comprises a dome-type camera.

3. A system according to claim 1, wherein said lens comprises a wide-angle lens.

4. A system according to claim 1, wherein said motion detector is fixedly mounted to said video camera.

5. A system according to claim 1, wherein said imager comprises a CCD imager.

6. A system according to claim 1, wherein said imager comprises a CMOS imager.

7. A system according to claim 1, wherein said motion detector further comprises a motion detect sequencer configured for monitoring said video data for said movement of said object.

8. A system according to claim 7, wherein said motion detector further comprises a controller for receiving an output of said motion detect sequencer, said controller being configured to provide said detector output.

9. A system according to claim 1, wherein said at least one operating characteristic comprises a pan, tilt or zoom characteristic of said video camera.

10. A system according to claim 1, wherein said detector output is provided to modify a pan, tilt and zoom characteristic of said video camera.

11. A system according to claim 1, said system further comprising at least one recording device, said recording device including a recording media, and wherein said detector is configured to provide a record command configured to cause said recording device to record at least a portion of a video output of said camera on said recording media while said camera is targeted on said object.

12. A system according to claim 1, said system comprising a plurality of said motion detectors.

13. A system according to claim 12, wherein said video data associated with each of said motion detectors is time multiplexed.

14. A system according to claim 12, wherein said field of view of at least two of said motion detectors overlap.

15. A system according to claim 12, wherein said field of view of each of said motion detectors overlap.

16. A system according to claim 12, wherein said motion detectors are configured in a circular pattern around said camera.

17. A system according to claim 12, wherein said fields of view of said motion detectors extend 360 degrees around said camera.

18. A system according to claim 12, wherein said motion detectors are affixed to an annular ring.

19. A system according to claim 18, wherein said annular ring is disposed around said camera.

20. A system according to claim 1, said system further comprising a user control interface coupled to said camera for controlling said camera in response to user-initiated input.

21. A system according to claim 1, wherein said imager comprises a low resolution imager.

22. A system comprising:
at least one video camera;
at least one motion detector comprising a wide-angle lens having a field of view fixedly directed to an area of interest, and an imager for receiving an image through said lens and converting said image to video data;
said motion detector being configured to monitor said video data for movement of an object in said field of view without application of at least one visual perception algorithm to said video data, and to provide a detector output in response to said movement of said object, said detector output being configured to cause adjustment of pan, tilt and zoom characteristics of said video camera to target said camera on said object; and
at least one recording device, said recording device including a recording media, said detector being configured to provide a record command configured to cause said recording device to record at least a portion of a video output of said camera on said recording media while said camera is targeted on said object.

23. A system according to claim 22, wherein said video camera comprises a dome-type camera.

24. A system according to claim 22, wherein said motion detector is fixedly mounted to said video camera.

25. A system according to claim 22, wherein said imager comprises a CCD imager.

26. A system according to claim 22, wherein said imager comprises a CMOS imager.

27. A system according to claim 22, wherein said motion detector further comprises a motion detection sequencer configured for monitoring said video data for said movement of said object.

28. A system according to claim 27, wherein said motion detector further comprises a controller for receiving an output of said motion detect sequencer, said controller being configured to provide said detector output.

29. A system according to claim 22, wherein said system further comprising a user control interface coupled to said camera for controlling said camera in response to user-initiated input.

30. A system according to claim 22, wherein said imager comprises a low resolution imager.

31. A motion detector comprising:
a lens, and an imager for receiving an image through said lens and converting said image to video data,
said motion detector being configured to monitor said video data for movement of an object in a field of view of said lens without application of at least one visual perception algorithm to said video data, and to provide a detector output in response to said movement of said object, said detector output being configured to cause adjustment of at least one operating characteristic of a video camera to target said camera on said object.

32. A motion detector according to claim 31, wherein said lens comprises a wide-angle lens.

33. A motion detector according to claim 31, wherein said imager comprises a CCD imager.

34. A motion detector according to claim 31, wherein said imager comprises a CMOS imager.

35. A motion detector according to claim 31, wherein said motion detector further comprises a motion detect sequencer configured for monitoring said video data for said movement of said object.

36. A motion detector according to claim 35, wherein said motion detector further comprises a controller for receiving an output of said motion detect sequencer, said controller being configured to provide said detector output.

37. A motion detector according to claim 31, wherein said at least one operating characteristic comprises a pan, tilt or zoom characteristic of said video camera.

38. A motion detector according to claim 31, wherein said detector output is provided to modify a pan, tilt and zoom characteristic of said video camera.

39. A motion detector according to claim 31, wherein said imager comprises a low resolution imager.

40. A method of monitoring a moving object in a video system, said method comprising:
providing at least one motion detector, said motion detector comprising a lens having a field of view fixedly directed to an area of interest, and an imager for receiving an image through said lens and converting said image to video data;
operating said motion detector to continually monitor said video data to detect movement of said moving object without application of at least one visual perception algorithm to said video data; and
providing an output from said motion detector in response to said movement to cause adjustment of at least one operating characteristic of a video camera to target said camera on said moving object.

41. A method according to claim 40, wherein said lens comprises a wide-angle lens.

42. A method according to claim 40, wherein said motion detector is configured to provide a record command configured to cause a recording device to record at least a portion of a video output of said camera on a recording media while said camera is targeted on said object.

43. A method according to claim 40, said method comprising providing a plurality of said motion detectors, each of said motion detectors being configured to monitor an associated stream of said video data.

44. A method according to claim 43, wherein said video data associated with each of said motion detectors is time multiplexed.

45. A method according to claim 43, wherein said field of view of at least two of said motion detectors overlap.

46. A method according to claim 43, wherein said field of view of each of said motion detectors overlap.

47. A method according to claim 43, wherein said motion detectors are configured in a circular pattern around said camera.

48. A method according to claim 43, wherein said fields of view of said motion detectors extend 360 degrees around said camera.

49. A method according to claim 43, wherein said motion detectors are affixed to an annular ring.

50. A method according to claim 49, wherein said annular ring is disposed around said camera.

51. A method according to claim 40, wherein said imager comprises a low resolution imager.

52. A method of monitoring multiple moving objects in a video system, said method comprising:
providing at least one motion detector, said motion detector comprising a lens having a field of view fixedly directed to an area of interest, and an imager for receiving an image through said lens and converting said image to video data;
operating said motion detector to continually monitor said video data to detect movement of said moving objects without application of at least one visual perception algorithm to said video data;
providing a plurality of outputs from said motion detector, each of said outputs being in response to movement of an associated one of said moving objects and being configured to cause adjustment of at least one operating characteristic of at least one associated video camera to target said at least one associated video camera on said associated one of said moving objects.

53. A method according to claim 52, wherein said outputs are sequentially provided.

54. A method according to claim 53, wherein said detector is configured to provide at least one record command to record video of each of said moving objects while said at least one camera is targeted thereon.

55. A method according to claim 52, wherein said lens comprises a wide-angle lens.
